(19) United States
(12) Patent Application Publication
(10) Pub. No.: US 2008/0095070 A1
(43) Pub. Date: Apr. 24, 2008

(54) Accessing an IP multimedia subsystem via a wireless local area network

(76) Inventors: Tat Keung Chan, San Diego, CA (US); Govindarajan Krishnamurthi, San Diego, CA (US); Inmaculada Carrion-Rodrigo, San Diego, CA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/634,528

(22) Filed: Dec. 5, 2006

Related U.S. Application Data
(60) Provisional application No. 60/742,952, filed on Dec. 5, 2005.

(51) Int. Cl. H04L 12/28; H04L 12/66; H04L 12/56

(52) U.S. Cl. 370/254; 370/338

(57) ABSTRACT

Method and equipment for use in connection with a wireless communication terminal accessing an IMS of a third generation telecommunication system via a WLAN, and in particular based on WLAN interworking scenario 3 and 4.

### CROSS REFERENCE TO RELATED APPLICATION

Reference is made to and priority claimed from U.S. provisional application Ser. No. 60/742,952, filed Dec. 5, 2005.

### BACKGROUND OF THE INVENTION

1. Technical Field

The present invention pertains to mechanisms for accessing an Internet Protocol (IP) Multimedia Subsystem (IMS) of a core network of a cellular communication system via a Wireless Local Area Network (WLAN) (instead of via a radio access network). In particular, the present invention provides solutions for accessing IMS through WLAN.

2. Discussion of Related Art

IMS, defined in 3GPP (Third Generation Partnership Program) standards and specifications and in 3GPP2 (Third Generation Partnership Program 2) standards and specifications, uses SIP (Session Initiation Protocol) for providing multimedia services to mobile users. 3G (Third Generation)/WLAN Inter-working (WLAN-IW) is being specified in 3GPP and 3GPP2. In 3GPP2, in place of IMS there is a Multimedia Domain (MMD).

In the following, 3GPP2 and 3GPP terminologies are used interchangeably unless otherwise noted, and the description of the invention provided below applies to both 3GPP and 3GPP2 unless explicitly indicated otherwise.

IMS and IMS AKA

According to 3GPP Technical Specification (TS) 33.203 V1.0.0 (Access Security for IP-based Services), IMS in UMTS (Universal Mobile Telecommunication System) supports IP multimedia applications such as conferencing using audio, video, and multimedia. 3GPP has chosen SIP as the signaling protocol for creating and terminating multimedia sessions. TS 33.203 specifies authentication (with an IM Services Identity Module, i.e. ISIM) using SIP signaling. In 3GPP2 documents, MMD is based on 3GPP IMS, with equivalents for most of the major functionalities and features of IMS. Note that 3GPP2 IMS (i.e. MMD) security is specified in S.R0086 or S.S0086.

IMS includes all core network (as opposed to radio access network) elements for provision of IP Multimedia (IM) services. IMS includes various instances of a Call Session Control Function (CSCF), namely a proxy CSCF (P-CSCF), an interrogating CSCF (I-CSCF), and a serving CSCF (S-CSCF), and IMS also includes a Home Subscriber Server (HSS). The HSS is the master database for a given UE (user equipment) device, i.e. a wireless communication device; it is the entity containing the subscription-related information for a UE to support the network entities actually handling calls/sessions. The P-CSCF is characterized by being the first contact point for the UE within the IMS; the S-CSCF actually handles the session states in the network; and the I-CSCF is mainly the contact point within an operator's network for all IMS. The term UE is used here to indicate a wireless terminal used for wireless communications, which includes equipment and logic for communication with a wireless local area network according to at least some 3GPP-WLAN interworking standards, and may or may not also include equipment for communication with a radio access network for a cellular communication system.

IMS services are not provided to a UE until a security association is established by IMS between the UE and IMS. (IMS is designed to be independent of the (access) network used to access IMS, and so it should be possible to access the IMS over either a wired or a wireless communication system.)

The ISIM (IMS Service Identity Module) is responsible for keys, sequence numbers (SQNs), and other similar objects/parameters tailored to the IMS. The security parameters handled by an ISIM are independent of corresponding security parameters for a User Services Identity Module (USIM).

According to TS 33.203, an IM subscriber has its subscriber profile located in the HSS in the home network. At registration, an S-CSCF is assigned to the subscriber by the I-CSCF. When the subscriber requests an IM service, the S-CSCF checks, by matching the request with the subscriber profile, if the subscriber is allowed to continue with the request or not.

The mechanism for authentication during registration in IMS is called IMS AKA (Authentication and Key Agreement), which is a challenge/response (secure) protocol. In IMS AKA, the home network authenticates a subscriber UE only via registrations (or re-registrations). IMS AKA provides shared keys for protecting IMS signaling between a UE and a P-CSCF. To protect IMS signaling between the UE and the P-CSCF it is also necessary to agree on a protection method (e.g. an integrity protection method) and to agree on a set of parameters specific to the protection method, e.g. the cryptographic algorithm to be used. The parameters negotiated between the UE and P-SCSF are typically part of what is called a security association (SA), to be used for a protection mechanism. Although the available protection mechanisms can be quite different in how they each function, there is a common set of parameters (i.e. there is a security association) that must be negotiated for each of them. This set of parameters includes: authentication (integrity) algorithm, and optionally an encryption algorithm; a SA identifier used to uniquely identify the security association at the receiving side; and a key length, i.e. the length of encryption and authentication (integrity) keys, which is usually taken to be 128 bits.

Before a UE can access IM services, at least one IM Public Identity (IMPU) must be registered and the IM Private Identity (IMPI) authenticated in the IMS at the application level. In order to be registered, the UE sends an SIP REGISTER message to the SIP registrar server, i.e. the S-CSCF, via the P-CSCF and the I-CSCF; the S-CSCF then authenticates the UE. When the P-CSCF and the I-CSCF forward the SIP REGISTER to the S-CSCF, they include their addresses in the messages.

PDIF

A PDIF (packet data interworking function) provides a secure end-to-end tunnel between a MS (mobile station, i.e. e.g. a mobile/cell phone, which is one kind of a UE device) and a tunnel termination point. A PDIF is used by a MS (or other UE device) as a gateway to services provided by a telecommunications system, including services provided by IMS. A more general example of its use is in providing a VPN (virtual private network). A PDIF can be located either in the home network of a MS or in a visited network. If the PDIF is located in the home network then the PDIF may be co-located with the HA (home agent, i.e. an element of the home network, provided as functionality hosted by a server of the home network). A PDIF located in a visited network will allow the MS access to packet data services provided by the visited network.

IPSec

IP-based communication terminals communicate via a layered protocol in which each upper layer uses services provided by the next lower layer, the lowest layer commonly indicated as the physical layer, which provides the actual communication signal. One upper layer is the network layer. IPsec (IP Security Protocol, whose architecture is specified in RFC 2401) provides confidentiality and integrity protection at the network layer.

In other words, IPsec protocols operate at the network layer, layer 3 of the OSI (Open Systems Interconnection) model. Other Internet security protocols in widespread use, such as SSL (Secure Sockets Layer) and TLS (Transport Layer Security), operate from the transport layer up (OSI layers 4-7). IPsec is therefore considered to be more flexible, as it can be used for protecting both (commonly known) TCP (Transmission Control Protocol) and UDP (User Datagram Protocol) based protocols, but has some additional complexity and processing overhead because it cannot rely on TCP (layer 4 OSI model) to manage reliability and fragmentation.

Nodes that want to exchange secure IPsec-protected traffic set up an IPSec security association, identified by the addresses of the nodes and by its SPI (Security Parameter Index); the SPI contains the security parameters (e.g. keys and algorithms) the nodes use to protect their traffic. IKE (Internet Key Exchange, specified in RFC 2409[97]) is the key management protocol commonly used in setting up a security association. Note that, however, IMS allows the setting up of the IPSec security associations between the UE and the P-CSCF during SIP registration, and does not make use of IKE.

There are two modes of IPsec operation: transport mode and tunnel mode.

In transport mode only the payload (message) of the IP packet is encrypted. Transport mode is typically used for host-to-host communications.

In tunnel mode, the entire IP packet is encrypted. It must then be encapsulated into a new IP packet for routing to work. Tunnel mode is typically used for network-to-network communications (secure tunnels between routers) or host-to-network and host-to-host communications over the Internet.

IPsec provides two protocols for securing packet flows. One is called the ESP (Encapsulating Security Payload) protocol, and the other is called AH (Authentication Header) protocol. ESP provides integrity and (optionally) confidentiality; AH provides only integrity. In the description of the invention that follows, any reference to IPSec assumes use of the ESP protocol, although one skilled in the art would understand how the AH protocol could be used instead.

ESP adds to each IP packet a header and a trailer; some parts of the ESP trailer are encrypted and integrity-protected, while other parts are not. The ESP header contains the SPI, the sequence number of the packet, and the initialization vector for the encryption algorithm. The ESP trailer contains optional padding in case it is required by the encryption algorithm and data related to authentication of the data (i.e., integrity protection of the data).

ESP (and IPSec generally) has two modes of operation: transport mode and tunnel mode. Transport mode is normally used between endpoints, while tunnel mode is typically used between security gateways to create virtual private networks.

ESP in transport mode protects the payload of an IP packet. For example, two entities exchanging TCP traffic using ESP transport mode would protect the TCP headers and the actual contents carried by TCP.

ESP in tunnel mode protects an entire IP packet by encapsulating it in another IP packet. The outer IP packet carries the IP addresses of the security gateways while the inner IP packet remains untouched. Note that the traffic between the endpoints and the security gateway may not be protected.

WLAN Interworking with IMS

3GPP has determined different possible scenarios of WLAN interworking with cellular networks, numbered to differentiate between them. A UE (device) may use different ones of the WLAN interworking (WLAN-IW) scenarios to access various network services, as defined in [3GPP WLAN-IW] and [3GPP2 WLAN-IW], including IMS services. The invention concerns accessing IMS service over WLAN-IW Scenarios 3 and 4.

WLAN-IW Scenario 3: FIG. 1 illustrates the network reference model for accessing IMS services over WLAN-IW Scenario 3. In WLAN-IW Scenario 3, a UE obtains IP connectivity (i.e. connects to the IMS of the home network) by first connecting to a WLAN and then, through the WLAN, connecting to the home network providing IP connectivity, i.e. providing the IMS, via a PDIF. Then the UE and the home network mutually authenticate (via communication through the PDIF and through the WLAN), and once the UE and the home network are mutually authenticated, an IPSec tunnel 11 is established between the UE and the PDIF, located in this case in the home network. Once the IPSec tunnel is established between the PDIF and the UE, the UE may then access the IMS (in various ways not encompassed by Scenario 3), i.e. by communications encapsulated within the communications to the PDIF, having a security association not prescribed by Scenario 3. In this case the P-CSCF is also located in the home network.

Thus, the UE and the IMS establish a communication channel/connection providing IP connectivity, i.e. allowing communication according to IP, i.e. communication of IP packets. This allows access to the Internet. The communication channel/connection has possibly different characteristics, at least in respect to security, between the UE and the PDIF (via the WLAN), and between the PDIF and the IMS. Scenario 3 specifies only what the security association is between the UE and the PDIF via the WLAN, and it specifies IPSec tunnel mode as the security association, configured to provide both integrity and confidentiality.

FIG. 2 also illustrates the network reference model for accessing IMS services over WLAN-IW Scenario 3. But in this case the PDIF is located in a visited network, and the P-CSCF is also located in the same visited network.

WLAN-IW Scenario 4: FIG. 3 illustrates the network reference model for accessing IMS services over WLAN-IW Scenario 4. In WLAN-IW Scenario 4, the UE again obtains IP connectivity through a WLAN, i.e. connects to the IMS of the home network mutually authenticates with the home network. And then, similarly to Scenario 3, once the UE and the home network mutually authenticate in the mobile IP registration process, an IPSec tunnel 11 is established between the UE and the Home Agent (HA). In FIG. 3, the HA is located in the home network. Once WLAN-IW Scenario 4 is completed, the UE may then access the IMS. In this case, the P-CSCF is also located in the home network.

FIG. 4 also illustrates the network reference model for accessing IMS services over WLAN-IW Scenario 4. This time, however, the HA is provided in a visited network. Moreover, the P-CSCF is also located in the same visited network.

It can be seen that the network reference model for Scenario 3 and Scenario 4 are logically similar, except that PDIF is replaced with HA. Therefore the following description of the invention is based on Scenario 3, but the invention can just as easily be based on Scenario 4 by replacing PDIF with HA. Similarly, the description is for the case where both PDIF and P-CSCF are in the home network (FIG. 1), but unless otherwise indicated, the case in which these entities are in the visited network (FIG. 2) is handled in the same way.

Security for accessing IMS is specified in 3GPP TS 33.203. Security for accessing early implementation of IMS (based on 2G SIM cards) is specified in 3GPP TS 33.978. Security for access 3GPP2 MMD resembles that in 3GPP and is specified in 3GPP2 S.R0086-A.

Some Problems Addressed by the Invention

According to the prior art, although 3GPP Rel-5 IMS does not have confidentiality protection, it is available in Rel-6, and also in an anticipated next version of 3GPP2 MMD security. Sometimes, however, confidentiality protection is unnecessary, because of security features of the communication between the UE and IMS in place when a UE connects to IMS via scenario 3 or 4. Retaining the confidentiality procedure imposes an additional unnecessary processing burden in such instances.

What is needed therefore are different ways for a UE to access IMS services via a WLAN, ideally including some ways in which access is made efficient by not including redundant or partially redundant confidentiality mechanisms for communication between the UE and the IMS.

### DISCLOSURE OF INVENTION

The invention provides various ways in which a UE can access IMS services via a WLAN, some of which eliminate redundant or partially redundant confidentiality mechanisms.

The invention provides a method for use by a user equipment wireless communication terminal in establishing internet protocol connectivity, comprising: communicatively coupling to a packet data interworking function or home agent of a home or visited network offering an internet protocol multimedia subsystem, wherein the coupling is via coupling to a wireless local area network, and establishing a security association with the packet data interworking function or home agent; and communicatively coupling to the internet protocol multimedia subsystem via a proxy call state control function of the home or visited network and establishing a security association with the proxy call state control function; wherein the security association with the proxy call state control function is configured so as not to duplicate any confidentiality protection provided by the security association with the packet data interworking function or home agent.

A corresponding user equipment wireless communication terminal, a method for use by a network, and a network are also provided, as well as computer program products including instructions for corresponding operation of user equipment and components of a network, and corresponding application specific integrated circuits.

### BRIEF DESCRIPTION OF THE DRAWINGS

The above and other objects, features and advantages of the invention will become apparent from a consideration of the subsequent detailed description presented in connection with accompanying drawings, in which:

FIG. 1 illustrates a prior art network reference model for accessing IMS over WLAN (referred to as WLAN IW Scenario 3, with PDIF and P-CSCF in the home network).

FIG. 2 illustrates a prior art network reference model for accessing IMS over WLAN (referred to as WLAN IW Scenario 3, with PDIF and P-CSCF in a visited network).

FIG. 3 illustrates a network reference model for accessing IMS over WLAN (referred to as WLAN IW Scenario 4, with HA and P-CSCF in the home network).

FIG. 4 illustrates a network reference model for accessing IMS over WLAN (referred to as WLAN IW Scenario 4, with HA and P-CSCF in a visited network).

FIG. 5 illustrates a UE accessing IMS according to an embodiment of the invention (called Solution 1: IMS AKA plus IMS level IPSec integrity protection but no IMS level IPSec encryption).

FIG. 6 illustrates a UE accessing IMS according to an embodiment of the invention (called Solution 2: IMS AKA with no IMS level IPSec integrity protection and no IMS level IPSec encryption).

FIG. 7 illustrates a UE accessing IMS according to an embodiment of the invention (called Solution 3: IMS AKA with no WLAN level IPSec tunnel).

FIG. 8 is a reduced block diagram (only portions relevant to the invention being shown) of a wireless communication terminal, such as a UE or such as would be found in a WLAN, including nonvolatile memory for storing processor instructions for operation according to the invention.

FIG. 9 is a flowchart illustrating what occurs according to the invention when a UE accesses an IMS.

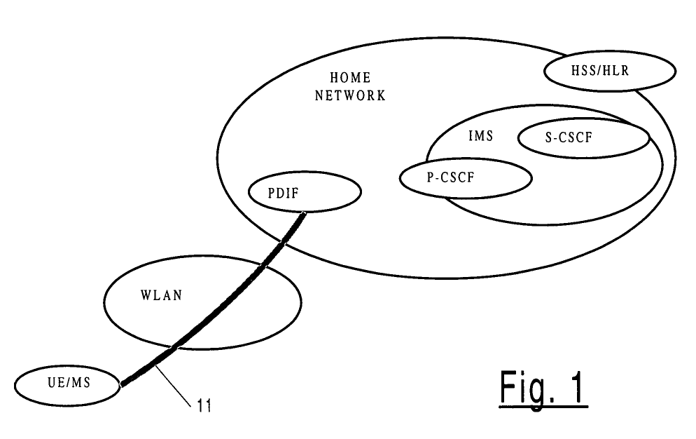

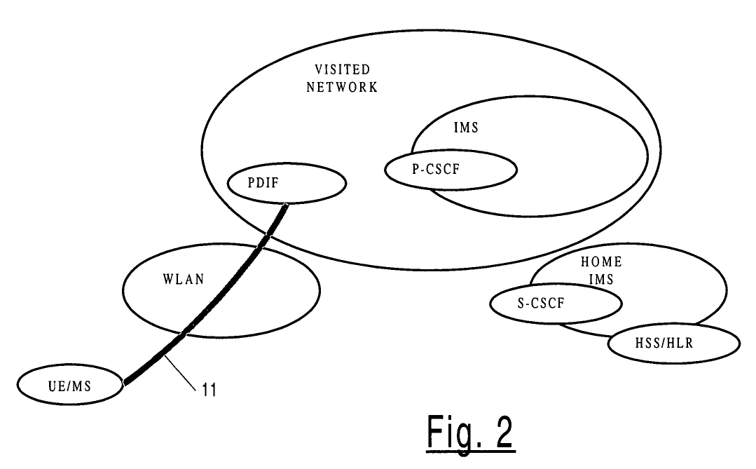

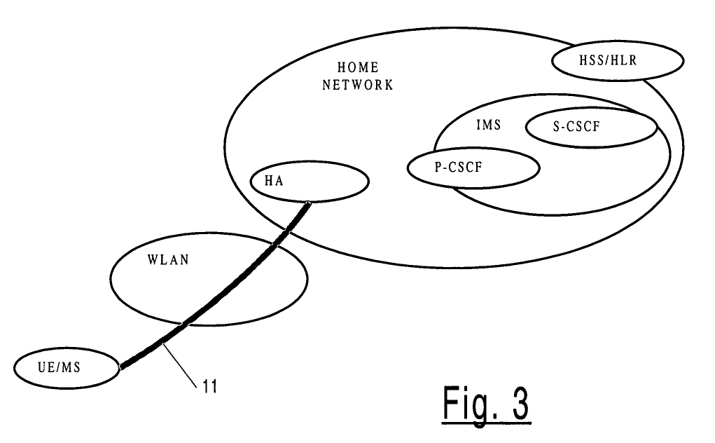

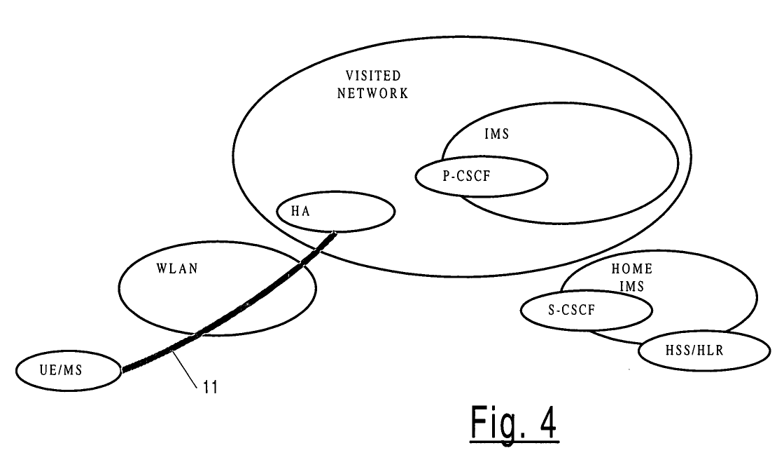

### DETAILED DESCRIPTION OF THE INVENTION

The invention provides various possible ways for a UE to access an IMS network, and hence IMS services, over a WLAN. A first embodiment is provided in which a 3GPP/3GPP2 IMS compliant security solution is used (IMS AKA and IMS level IPSec integrity protection but no IMS level IPSec encryption). A second embodiment is provided in which IMS level IPSec integrity protection is not set up and so there is neither IMS level integrity protection (via authentication) nor confidentiality (via encryption). A third embodiment is provided in which IPSec tunnel mode protection at the WLAN level is turned off, as opposed to the first embodiment where it remains on. Each of these alternatives uses IMS level authentication. A fourth embodiment is also provided, in which IMS level authentication is not performed but is instead implicit.

### First Embodiment

### Using 3GPP/3GPP2 IMS Compliant Security Solution (IMS AKA and IMS Level IPSec Integrity Protection but no IMS Level IPSec Encryption)

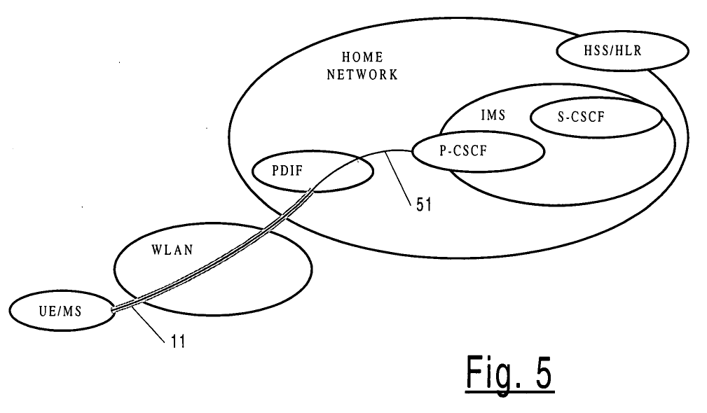

Referring now to FIG. 5, in a first embodiment of the invention a 3GPP/3GPP2 IMS compliant security solution is used, but without IMS level IPSec encryption (confidentiality protection), i.e. with only IMS level IPSec integrity protection (provided by authentication). In this, a communication channel/connection between a UE and the IMS is established via the PDIF of the network providing the IMS; the communication channel/connection comprises a connection via a WLAN to the PDIF according to WLAN-IW Scenario 3 and so having a security association based on IPSec in tunnel mode, and, encapsulated therein, a connection from the UE to the IMS via the PDIF using a different security association. To establish the communication channel, first the UE connects to the WLAN, and thereby to the home network, and then mutually authenticates with the home network. Then once the UE and the home network are mutually authenticated, a first IPSec security association 11, called here an IPSec tunnel, is established between the UE and the PDIF (in Scenario 3, assumed here, but HA in scenario 4). Next, authentication at the IMS level is performed, based on IMS AKA (Authentication and Key Agreement). Then after successful IMS authentication, a second IPSec security association 51, providing IPSec in transport mode and configured for providing only integrity protection, is established between the UE and the P-CSCF thereby providing IMS level IPSec integrity protection, but not IMS level IPSec encryption.

As a result, there are two IPSec security associations used in the signalling path: IPSec in tunnel mode 11 between the UE and the PDIF providing integrity protection and privacy/confidentiality protection (via encryption), and IPSec in transport mode 51 between the UE and the P-CSCF, configured for providing only integrity protection. In other words, there is one IPSec security association, an IPSec tunnel, between the UE and PDIF (or HA), which is at the WLAN level, and there is another IPSec security association, an IPSec in transport mode, between the UE and P-CSCF, which is at the SIP/IMS level. With this embodiment, the UE is provided so as to support IPSec in transport mode within the connection using IPSec in tunnel mode.

In this, unnecessary double privacy protection and the corresponding complexity is avoided by not having encryption in the (second) security association 51 between the UE and the P-CSCF, i.e. the security association using IPSec in transport mode. Thus, when a UE accesses IMS via a WLAN and the P-CSCF determines that the UE is connecting according to WLAN-IW scenario 3 or 4 (i.e. that an IPSec tunnel mode security association is in place with the PDIF), the P-CSCF turns off or does not activate IMS level confidentiality protection (provided using encryption) for the UE (by not selecting any confidentiality protection/encryption algorithms in the security mechanism agreement during IMS authentication). One way to turn off or not activate confidentiality protection at the IMS level is for the P-CSCF to not include any encryption algorithms in the security-setup line in security association negotiation during SIP signaling. Alternatively, the encryption algorithm at the IMS level can be set to null. Note that in such a case the UE to P-CSCF IPSec connection still exists and still provides integrity protection, because integrity protection is mandatory in IMS. However, since encryption is comparatively more computationally expensive, removing one level of encryption can greatly improve the efficiency of the communication between the UE and IMS.

IMS level (integrity) protection may also be provided through other means, e.g. through TLS (Transport Layer Security) between the UE and P-CSCF. It should be noted that the solution here would work similarly in such instances.

Note that in this embodiment, where no confidentiality protection is provided at the SIP level between the UE and P-CSCF, the security between the PDIF and P-CSCF is provided by network domain security. If both PDIF and P-CSCF belong to the same network, then it is straightforward to set up this security. For instance, it could be provided by physical security such that the connection between the PDIF and P-CSCF is privately owned by the network operator. If PDIF and P-CSCF belong to different network operators, inter-network security has to be provided to protect the traffic between the two network entities. Note also that in some cases, if PDIF and P-CSCF belong to two different network operators, the user or the home network may still want to encrypt the IMS level traffic from the network hosting the PDIF, for privacy protection purposes, in which case the IMS level confidentiality should be maintained.

### Second Embodiment

### Using IMS AKA with no IMS Level IPSec Protection (i.e. Neither Integrity Protection nor Confidentiality Protection)

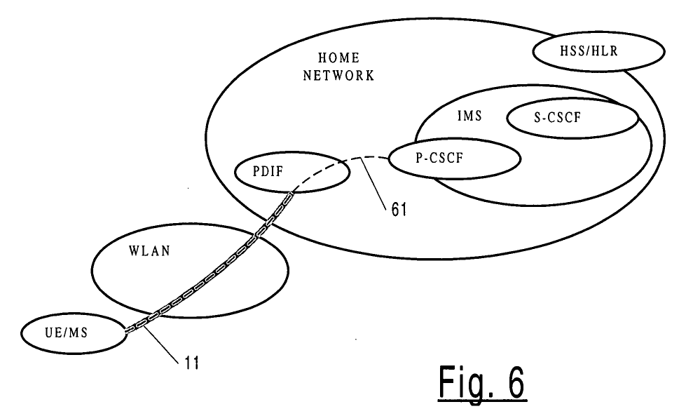

Referring now to FIG. 6, an alternative to the first embodiment is for the UE to access IMS in the same way as in the first embodiment, but to turn off or not activate the IMS level integrity protection (either), so that there is neither IMS level IPSec integrity protection nor IMS level IPSec encryption. So in this embodiment, the IMS level IPSec connection between UE and P-CSCF is not set up at all. Thus, in this embodiment there is only a single security association, an IPSec tunnel mode security association 11, and there is in effect a null security association 61 between the UE and the P-CSCF. So in this embodiment, when a UE accesses IMS via a WLAN and the P-CSCF knows that the UE is connecting from WLAN-IW scenario 3 or 4, the P-CSCF turns off (or does not activate) IMS level protection for the UE, neither integrity protection nor confidentiality protection. In other words, the P-CSCF indicates to the UE that no IMS level protection is required, and the IMS level IPSec security associations are not set up or are turned off.

Note that in this embodiment, where only IPSec in tunnel mode between the UE and PDIF is used, any security between the PDIF and P-CSCF is provided by network domain security.

### Third Embodiment

### Using IMS AKA with no WLAN IPSec Protection

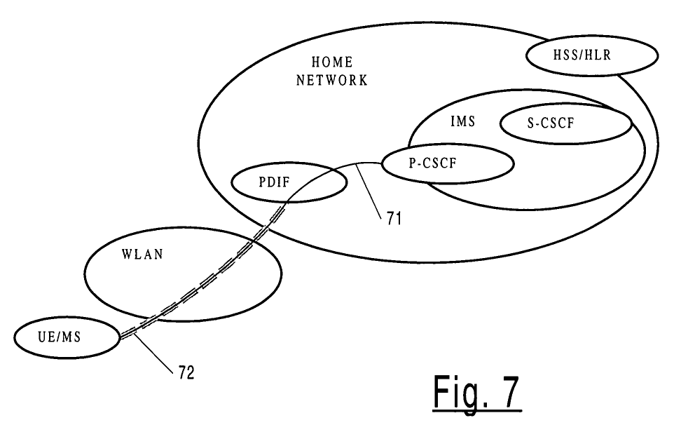

Referring now to FIG. 7, another alternative to the first embodiment is for the UE to access IMS in the same way as in the first embodiment, but to do so without using the WLAN IPSec tunnel mode, i.e. without using WLAN-level confidentiality (and integrity) protection. Thus, in this embodiment there is also only one security association: an IPSec transport mode security association 71 between the P-CSCF and the UE, but unlike in the first embodiment, which also uses an IPSec in transport mode security association, the security association in this third embodiment is typically configured to provide both integrity protection and also confidentiality protection. The IPSec tunnel mode security association is not used, and so is indicated in FIG. 7 as a null security association 72.

In this embodiment, the UE should indicate to the PDIF during WLAN IW Scenario 3 authentication procedure that the connection will only be used for accessing IMS services and no other services. The PDIF may decide that in this case WLAN level IPSec tunnel security is not required and indicate this decision to the UE. In that case then, the WLAN level IPSec tunnel would not be established.

In this embodiment, i.e. in case of maintaining the IMS level confidentiality and integrity but turning off or not activating the IPSec tunnel mode between the UE and the PDIF, since the IPSec tunnel provided by WLAN-IW may be used by the UE to access services other than IMS, and since those other services may not provide their own security mechanisms, turning off the IPSec tunnel is advantageously only done when the WLAN connectivity is only used for IMS access.

### Fourth Embodiment

### Implicit Authentication at IMS Level

It may be argued that since the UE is authenticated in WLAN-IW Scenario 3 at the WLAN level, another level of authentication, at the IMS level, (i.e. at registration, as opposed to the packet-by-packet authentication provided by IPSec at the IMS level, and noted above as providing integrity protection at the IMS level) may not be required, provided that there is a binding between the IP address obtained and the SIP level user identities (i.e. e.g. the IMPI and/or possibly the IMPU). Thus, the invention provides yet another embodiment, an embodiment that amounts to a difference in procedure that can be used in any of the above three embodiments. In this embodiment, IMS level authentication is not performed, but is instead implicit. In this embodiment:

(a) a UE and a (home or visited) network perform WLAN-IW Scenario 3 (or 4) authentication. Upon successful completion, the UE is assigned an IP address by the PDIF. An IPSec tunnel providing (at least) integrity protection is then established between the UE and the PDIF, i.e. there is integrity protection/authentication at the WLAN level.

(b) The PDIF then notifies the home HSS/HLR (Home Location Register) of the user about the IP address assigned. (The HSS/HLR stores address binding for the user in a database.)

(c) The UE then performs SIP level registration by sending an SIP REGISTER message to the P-CSCF of the network.

(d) The SIP REGISTER message eventually arrives at a S-CSCF of the network, which verifies with the HSS/HLR that the claimed IP address in the SIP REGISTER message matches that stored in the HSS/HLR database. If so, the user is considered to be authenticated, and so IMS-level authentication is not performed, and therefore IPSec integrity protection between the UE and the P-CSCF is not used.

So, in the first three embodiments, AKA is performed during UE registration in order to provide IMS-level authentication. In this fourth embodiment, on the other hand, AKA is not performed, and instead authentication is implicit, i.e. WLAN level authentication implies the UE is authenticated at the IMS level.

Other Aspects Associated with the Problem of Accessing IMS Over WLAN

Distinguishing Access Technologies by IMS

To provide interoperability of IMS access through various access technologies (3G, 2G (early IMS), WLAN-IW Scenario 3, and Scenario 4), it may be required for the IMS to distinguish between the different access technologies when an SIP request is received. Such an indication may be provided, for example, by including an indication of the type of access in the P-Access-Network-info header in SIP signalling being specified in the 3GPP2 MMD specification.

Note on P-CSCF Discovery

If the UE attempts to use the IMS services in a visited network, in which case both the PDIF and P-CSCF are in the visited network, then the address of the P-CSCF may be discovered through one of the following mechanisms:

1. Preconfiguration.

2. Using a DHCP (Dynamic Host Configuration Protocol) server, as specified e.g. in the 3GPP2 MMD specification (Section 9.2.1, X.S0013-004-0).

3. Using IKEv2 (Internet Key Exchange, version 2) signaling during WLAN-IW in a similar way to the TIA (Tunnel Inner Address) discovery as specified in e.g. the WLAN-IW Phase 2 specification (Section 5.6.1, X.P0028-200). In this case, the UE attaches a request in the IKEv2 signalling message to ask for the local P-CSCF address. The PDIF then determines the local P-CSCF IP address, and then responds to the UE using a configuration payload in the IKEv2 response.

Regarding Implementation

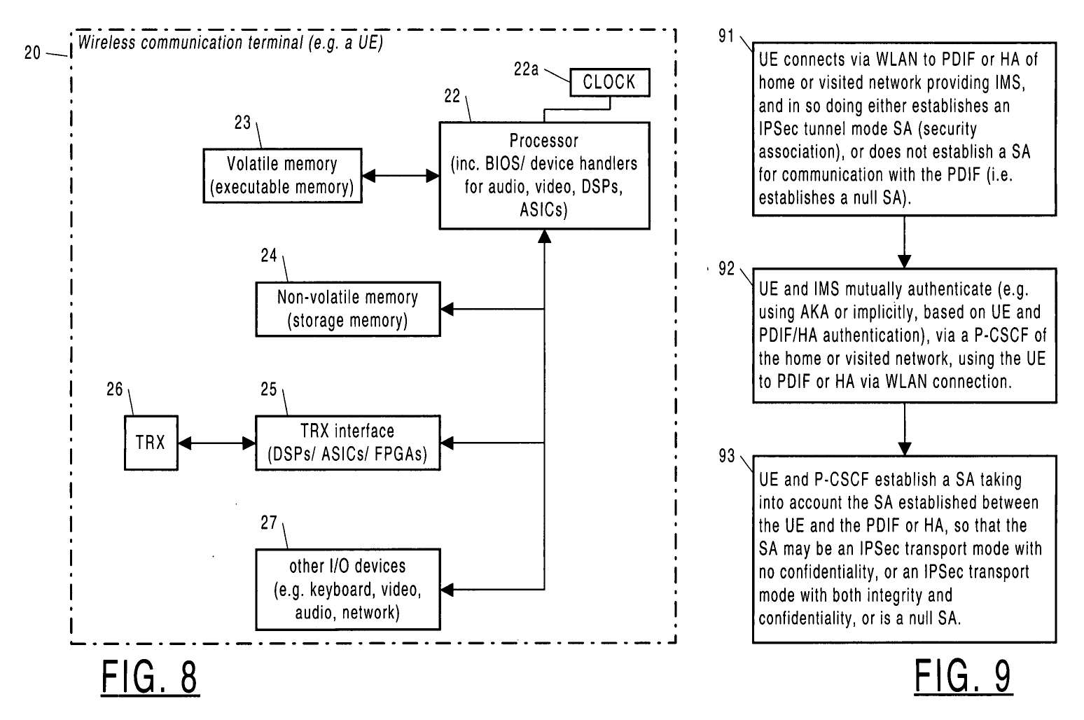

FIG. 8 shows some components of a communication terminal 20, which could be either a UE (wireless communication terminal) or a communication terminal of the WLAN of FIGS. 5-7, which can communicate wirelessly and also via a wireline. The communication terminal 20 includes a processor 22 for controlling its operation, including all input and output. The processor, whose speed/timing is regulated by a clock 22a, may include a BIOS (basic input/output system) or may include device handlers for controlling user audio and video input and output as well as user input from a keyboard. The BIOS/device handlers may also allow for input from and output to a network interface card. The BIOS and/or device handlers also provide for control of input and output to a transceiver (TRX) 26 via a TRX interface 25 including possibly one or more digital signal processors (DSPs), application specific integrated circuits (ASICs), and/or field programmable gate arrays (FPGAs). The TRX enables wireless communication (i.e. over the air) with another similarly equipped communication terminal. The communication terminal may also include (depending on the application) other I/O devices, such as a keyboard and a mouse or other pointing device, a video display, a speaker/microphone, and also a network interface (card), allowing wireline communication with other communication terminals, and in particular such communication over the Internet.

Still referring to FIG. 8, the communication terminal includes volatile memory, i.e. so-called executable memory 23, and also non-volatile memory 24, i.e. storage memory. The processor 22 may copy applications (e.g. a calendar application or a game) stored in the non-volatile memory into the executable memory for execution. The processor functions according to an operating system, and to do so, the processor may load at least a portion of the operating system from the storage memory to the executable memory in order to activate a corresponding portion of the operating system. Other parts of the operating system, and in particular often at least a portion of the BIOS, may exist in the communication terminal as firmware, and are then not copied into executable memory in order to be executed. The booting up instructions are such a portion of the operating system.

Still referring to FIG. 8, the communication terminal 20 is representative of a UE, a communication terminal of a WLAN, a PDIF or HA, and an IMS server, although not all of these may include all of the components shown in FIG. 8, but all would include the processor 22, the volatile memory 23, and the non-volatile memory 24. The volatile memory 23 is sometimes also called executable random access memory (RAM). Operation according to the invention of a UE, a communication terminal of a WLAN, a PDIF or HA, and an IMS server, is typically based on instructions stored in the non-volatile memory 24 and loaded into the volatile memory 23 for execution by the processor 22. (In other words, the processor is configured to operate as required by loading into the executable RAM the software stored in the non-volatile memory.)

Alternatively, at least some of the functionality required for operation according to the invention can be provided by one or more application specific integrated circuits, i.e. so that the logic required for operation according to at least some aspects of the invention is provided as hardware instead of software, as an integrated circuit.

Referring now to FIG. 9, operations by which a UE establishes IP connectivity according to embodiments of the invention is shown as including a first step 91 in which a UE connects via a WLAN to a PDIF or HA of its home or a visited network providing IMS, and in so doing either establishes an IPSec tunnel mode security association, or establishes a null security association (i.e. agrees to communicate without integrity or confidentiality protection) for communication with the PDIF. In a next step 92, the UE and IMS mutually authenticate (e.g. using AKA, but also, as in the fourth embodiment, based on the S-CSCF comparing the IP address for the UE stored in the HSS/HLR with the IP address in the SIP REGISTER message, i.e. implicitly) via a P-CSCF of the home or visited network, using the UE to PDIF or to HA connection provided via the WLAN. In a next step 93, the UE and P-CSCF establish a security association (which may be a null security association) based on the security association (which may be null) established between the UE and the PDIF or HA, and so is either an IPSec transport mode with no confidentiality, or an IPSec transport mode with both integrity and confidentiality, or is a null security association.

Operation of the UE and elements of the WLAN and home or visited network referred to in FIG. 9 may be provided by a computer program product, i.e. a computer readable storage structure, such as a free-standing disk used for non-volatile memory storage, embodying computer program code thereon for execution by a computer processor. The computer program code provides instructions by which the processor is caused to operate according to one or another embodiment of the invention, and differs depending on whether the instructions are for a UE, the element of a WLAN to which the UE would connect, the PDIF or HA, or the P-CSCF or other element of an IMS.

Concluding Remarks

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method for use by a user equipment wireless communication terminal in establishing internet protocol connectivity, comprising:
communicatively coupling to a packet data interworking function or home agent of a home or visited network offering an internet protocol multimedia subsystem, wherein the coupling is via coupling to a wireless local area network, and establishing a security association with the packet data interworking function or home agent; and
communicatively coupling to the internet protocol multimedia subsystem via a proxy call state control function of the home or visited network and establishing a security association with the proxy call state control function;
wherein the security association with the proxy call state control function is configured so as not to duplicate any confidentiality protection provided by the security association with the packet data interworking function or home agent.

2. A method as in claim 1, wherein the security association with the packet data interworking function or home agent is an internet protocol network-layer tunnel security association configured to provide confidentiality protection and also integrity protection, and the security association with the proxy call state control function is an internet protocol network-layer security association in transport mode configured to provide only integrity protection.

3. A method as in claim 1, wherein the security association with the packet data interworking function or home agent is an internet protocol network-layer tunnel security association configured to provide confidentiality protection and also integrity protection, and the security association with the proxy call state control function is a null security association providing neither integrity protection nor confidentiality protection.

4. A method as in claim 1, wherein the security association with the packet data interworking function or home agent is a null security association providing neither confidentiality protection nor integrity protection, and the security association with the proxy call state control function is an internet protocol network-layer security association in transport mode configured to provide both integrity protection and confidentiality protection.

5. A method as in claim 1, wherein the communicative coupling to the internet protocol multimedia subsystem via the proxy call state control function is established with internet protocol multimedia subsystem-level authentication based on a serving call state control function of the home or visited network referring to an internet protocol address for the user equipment provided to a home subscriber server and/or home location register by the packet data interworking function or home agent during authentication with the packet data interworking function or home agent, and comparing the internet protocol address stored in the home subscriber server/home location register with an internet protocol address provided by the user equipment in a session initiation protocol register message, instead of by use of authentication and key agreement signaling between the user equipment and the serving call state control function.

6. A computer program product comprising a computer readable storage structure embodying computer program code thereon for execution by a computer processor hosted by a user equipment communication terminal, wherein said computer program code comprises instructions for performing a method according to claim 1.

7. An application specific integrated circuit configured for operation according to claim 1.

8. A user equipment wireless communication terminal, comprising a processor and stored instructions by which the processor is configurable for:
communicatively coupling to a packet data interworking function or home agent of a home or visited network offering internet protocol multimedia subsystem, wherein the coupling is via coupling to a wireless local area network, and establishing a security association with the packet data interworking function or home agent; and
communicatively coupling to the internet protocol multimedia subsystem via a proxy call state control function of the home or visited network and establishing a security association with the proxy call state control function;
wherein the security association with the proxy call state control function is configured so as not to duplicate any confidentiality protection provided by the security association with the packet data interworking function or home agent.

9. A user equipment wireless communication terminal as in claim 8, wherein the security association with the packet data interworking function or home agent is an internet protocol network-layer tunnel security association configured to provide confidentiality protection and also integrity protection, and the security association with the proxy call state control function is an internet protocol network-layer security association in transport mode configured to provide only integrity protection.

10. A user equipment wireless communication terminal as in claim 8, wherein the security association with the packet data interworking function or home agent is an internet protocol network-layer tunnel security association configured to provide confidentiality protection and also integrity protection, and the security association with the proxy call state control function is a null security association providing neither integrity protection nor confidentiality protection.

11. A user equipment wireless communication terminal as in claim 8, wherein the security association with the packet data interworking function or home agent is a null security association providing neither confidentiality protection nor integrity protection, and the security association with the proxy call state control function is an internet protocol network-layer security association in transport mode configured to provide both integrity protection and confidentiality protection.

12. A user equipment wireless communication terminal as in claim 8, wherein the communicative coupling to the internet protocol multimedia subsystem via the proxy call state control function is established with internet protocol multimedia subsystem-level authentication based on a serving call state control function referring to an internet protocol address for the user equipment provided to a home subscriber server/home location register by the packet data interworking function or home agent during authentication with the packet data interworking function or home agent, and comparing the internet protocol address stored in the home subscriber server/home location register with an internet protocol address provided by the user equipment in a session initiation protocol register message, instead of by use of authentication and key agreement signaling between the user equipment and the serving call state control function.

13. A system, comprising a user equipment wireless communication terminal as in claim 8, and further comprising the packet data interworking function or home agent and the internet protocol multimedia subsystem of the home or visited network, and further comprising the wireless local area network.

14. A user equipment wireless communication terminal, comprising:
means for communicatively coupling to a packet data interworking function or home agent of a home or visited network offering internet protocol multimedia subsystem, wherein the coupling is via coupling to a wireless local area network, and establishing a security association with the packet data interworking function or home agent; and
means for communicatively coupling to the internet protocol multimedia subsystem via a proxy call state control function of the home or visited network and establishing a security association with the proxy call state control function;
wherein the security association with the proxy call state control function is configured so as not to duplicate any confidentiality protection provided by the security association with the packet data interworking function or home agent.

15. A method for use by a network in providing internet protocol connectivity, comprising:
communicatively coupling to a user equipment wireless communication terminal via a packet data interworking function or home agent of the network, wherein the coupling is via coupling to a wireless local area network, and establishing a security association between the user equipment and the packet data interworking function or home agent; and
communicatively coupling an internet protocol multimedia subsystem of the network to the user equipment via a proxy call state control function of the network, and establishing a security association between the user equipment and the proxy call state control function;
wherein the security association with the proxy call state control function is configured so as not to duplicate any confidentiality protection provided by the security association with the packet data interworking function or home agent.

16. A method as in claim 15, wherein the security association with the packet data interworking function or home agent is an internet protocol network-layer tunnel security association configured to provide confidentiality protection and also integrity protection, and the security association with the proxy call state control function is an internet protocol network-layer security association in transport mode configured to provide only integrity protection.

17. A method as in claim 15, wherein the security association with the packet data interworking function or home agent is an internet protocol network-layer tunnel security association configured to provide confidentiality protection and also integrity protection, and the security association with the proxy call state control function is a null security association providing neither integrity protection nor confidentiality protection.

18. A method as in claim 15, wherein the security association with the packet data interworking function or home agent is a null security association providing neither confidentiality protection nor integrity protection, and the security association with the proxy call state control function is an internet protocol network-layer security association in transport mode configured to provide both integrity protection and confidentiality protection.

19. A method as in claim 15, wherein the communicative coupling to the internet protocol multimedia subsystem via the proxy call state control function is established with internet protocol multimedia subsystem-level authentication based on a serving call state control function referring to an internet protocol address for the user equipment provided to a home subscriber server/home location register by the packet data interworking function or home agent during authentication with the packet data interworking function or home agent, and comparing the internet protocol address stored in the home subscriber server/home location register with an internet protocol address provided by the user equipment in a session initiation protocol register message, instead of by use of authentication and key agreement signaling between the user equipment and the serving call state control function.

20. A computer program product comprising a computer readable storage structure embodying computer program code thereon for execution by one or more computer processors of a telecommunication system providing internet protocol multimedia services, wherein said computer program code comprises instructions for performing a method according to claim 15.

21. An application specific integrated circuit configured for operation according to claim 15.

22. A network, comprising a packet data interworking function or home agent, and comprising an internet protocol multimedia subsystem in turn comprising a proxy call state control function and a serving call state control function,
wherein the packet data interworking function or home agent is configured for communicatively coupling via a wireless local area network to a user equipment wireless communication terminal, and for establishing a security association with the user equipment,
wherein the proxy call state control function is configured for communicatively coupling to the user equipment and for establishing a security association with the user equipment, and
wherein the security association with the proxy call state control function is configured so as not to duplicate any confidentiality protection provided by the security association with the packet data interworking function or home agent.

23. A network as in claim 22, wherein the security association with the packet data interworking function or home agent is an internet protocol network-layer tunnel security association configured to provide confidentiality protection and also integrity protection, and the security association with the proxy call state control function is an internet protocol network-layer security association in transport mode configured to provide only integrity protection.

24. A network as in claim 22, wherein the security association with the packet data interworking function or home agent is an internet protocol network-layer tunnel security association configured to provide confidentiality protection and also integrity protection, and the security association with the proxy call state control function is a null security association providing neither integrity protection nor confidentiality protection.

25. A network as in claim 22, wherein the security association with the packet data interworking function or home agent is a null security association providing neither confidentiality protection nor integrity protection, and the security association with the proxy call state control function is an internet protocol network-layer security association in transport mode configured to provide both integrity protection and confidentiality protection.

26. A network as in claim 22, wherein the communicative coupling to the internet protocol multimedia subsystem via the proxy call state control function is established with internet protocol multimedia subsystem-level authentication based on a serving call state control function referring to an internet protocol address for the user equipment provided to a home subscriber server/home location register by the packet data interworking function or home agent during authentication with the packet data interworking function or home agent, and comparing the internet protocol address stored in the home subscriber server/home location register with an internet protocol address provided by the user equipment in a session initiation protocol register message, instead of by use of authentication and key agreement signaling between the user equipment and the serving call state control function.

27. A system, comprising a network as in claim 22, the wireless local area network, and the user equipment wireless communication terminal.

28. A method for use by an element of a proxy call state control function for an internet protocol multimedia subsystem of a cellular communication network, comprising:
communicatively coupling to a user equipment wireless communication terminal via a wireless local area network so as to establish a communication path to the user equipment via the wireless local area network; and
communicating with the user equipment;
wherein the communicative coupling includes internet protocol multimedia subsystem authentication and key agreement making possible integrity protection at the internet protocol multimedia subsystem level via an internet protocol security in transport mode security association, and the communicative coupling is also provided at the wireless local area network level via an internet protocol security tunnel security association between the user equipment and a packet data interworking function or home agent of the cellular communication network; and
wherein the proxy call state control function turns off or does not activate confidentiality protection as part of the internet protocol security in transport mode security association based on determining that the user equipment is communicating via a wireless local area network.

29. A computer program product comprising a computer readable storage structure embodying computer program code thereon for execution by a computer processor, wherein said computer program code comprises instructions for performing a method according to claim 28.

30. A proxy call state control function of an internet protocol multimedia subsystem of a cellular communication network, comprising means for performing the method of claim 28.
